(19) United States
(12) Patent Application Publication
(10) Pub. No.: US 2023/0308034 A1
(43) Pub. Date: Sep. 28, 2023

(54) MULTI-PHASE ELECTRICAL TRANSFORMER AND POWER CONTROL APPARATUS

(71) Applicant: Third Equation Ltd, London (GB)

(72) Inventors: Andrew John SCOBIE, London (GB); Yihong WAN, London (GB)

(73) Assignee: Third Equation Ltd, London (GB)

(21) Appl. No.: 18/022,092

(22) PCT Filed: Aug. 20, 2021
(86) PCT No.: PCT/AU2021/050926

§ 371 Date: Feb. 17, 2023

(30) Foreign Application Priority Data
Aug. 20, 2020 (AU) 2020902972

(51) Int. Cl. H02P 13/12; H02M 1/12; H02M 5/458; H01F 29/14

(52) U.S. Cl. CPC H02P 13/12; H02M 1/12; H02M 5/4585; H01F 29/14; H01F 2029/143

(57) ABSTRACT

An electrical power control apparatus, including: a magnetic core having a plurality of phase limbs for respective phases of electric power, each of the phase limbs being interconnected to the other phase limbs at respective ends of the limb; primary windings around the respective phase limbs to receive input electrical energy in the form of input signals for the respective electrical phases and generate corresponding magnetic fluxes in the phase limbs; secondary windings around the respective phase limbs to generate output electrical energy in the form of output signals for respective electrical phases from magnetic fluxes in the phase limbs; and control windings around respective portions of the magnetic core to receive control signals for respective electrical phases to modify the magnetic fluxes in the respective phase limbs in order to modify the output signals generated from the secondary windings so that the output signals have one or more electrical attributes that satisfy respective predetermined criteria.

### TECHNICAL FIELD

The present invention relates to the supply of electrical power, and in particular to a multi-phase electrical transformer and a multi-phase electrical power control apparatus.

### BACKGROUND

The electricity system is undergoing a change of scale not seen for decades. The traditional model of centralised large-scale generation providing electricity and inertia is changing to allow for carbon-free generation technologies such as solar and wind to supply a greater percentage of our electricity needs. This, combined with an increasing uptake in electric vehicles and electrification of heating systems is resulting in a system where the way we generate and use electricity has changed to a more decarbonised, decentralised, digitised and democratised system, but the way we transport it has not evolved and is no longer fit for purpose.

Energy System Challenges

The fundamental design of the electricity grid has not changed in more than 100 years. It is based on a hub and spoke delivery system, with electricity flowing one way from large generators to tranched consumers. The distances travelled are generally quite large, spanning hundreds and sometimes thousands of kilometres, resulting in significant energy losses. The entire system is generator-centric in that generators act to balance the grid by controlling the amount of power that is generated to match the amount of power that is consumed. The traditional generators provide both the real power consumed, as well as other services such as inertia to the grid to maintain stability.

Traditional generation such as coal fire power plants use a spinning turbine to generate electricity. The spinning mechanical inertia stored in the spinning turbine provides immediate acting synchronous power reserves for the system when an imbalance occurs.

Electricity generated from renewable sources such as wind and solar still provide the real power required, however they do not provide any inertia. This is primarily due to the fact that the generating elements are not physically connected to the system. The properties of these renewable generators are also volatile: the voltage, harmonics and phase can change rapidly, but the electricity system cannot cope with these rapid changes.

Renewable energy generation is becoming cheaper than traditional generators because the marginal cost of production is very low. In particular, whereas coal power plants require a consumable input of coal to generate power, wind and solar only require the wind and the sun, which are freely available. However, because of the volatile nature of generation as described above, the electricity grid must be provided with balancing services to maintain the fragile balance of supply and demand in real time to provide a reliable power supply. As the percentage of renewable energy generation increases, so does the balancing services requirement. This has led to higher energy prices, for example in the USA the cost of energy is made up of 40% non-wholesale costs, and in some states such as New York this rises to 90% (source EIA). In Germany, the non-wholesale cost of energy accounts for 80.7% of the price of energy (source BDEW 2017).

Energy System Pricing Models

Most electricity systems globally operate in an energy market where generators bid to provide energy at a cost. The market operator then selects a mix of the cheapest generation to supply the predicted demand for a specified period, which is usually 30 minutes.

However, the changes to the electricity system described above significantly affect this practice in a number of ways. First, renewable generation is not dispatchable like traditional generation: it is dependent on the weather, which is outside the generators' control. This means the generators at times do not meet their generation requirements, or affect the short-term system stability by immediately starting or stopping generation. Renewable generators often underestimate the amount of energy they will produce in order to avoid undersupply and the associated financial penalties, which means these generators have to curtail excess energy.

Additionally, geographically distributed power generation means that the power flows within the electricity grid are changing, both in quantity and sometimes direction. The grid owner and operator generally have no insight as to what is happening within the system, as monitoring instrumentation was not previously required in these locations. This makes it more challenging for the grid to be kept operating effectively and efficiently.

It is desired to overcome or alleviate one or more difficulties of the prior art, or to at least provide a useful alternative.

### SUMMARY

In accordance with some embodiments of the present invention, there is provided an electrical power control apparatus, including:
a magnetic core having a plurality of phase limbs for respective phases of electric power, each of the phase limbs being interconnected to the other phase limbs at respective ends of the limb;
primary windings around the respective phase limbs to receive input electrical energy in the form of input signals for the respective electrical phases and generate corresponding magnetic fluxes in the phase limbs;
secondary windings around the respective phase limbs to generate output electrical energy in the form of output signals for respective electrical phases from magnetic fluxes in the phase limbs; and
control windings around respective portions of the magnetic core to receive control signals for respective electrical phases to modify the magnetic fluxes in the respective phase limbs in order to modify the output signals generated from the secondary windings so that the output signals have one or more electrical attributes that satisfy respective predetermined criteria.

In some embodiments, each of the phase limbs is interconnected to the other phase limbs only at respective ends of the phase limb.

In other embodiments, the magnetic core further includes coupling limbs that interconnect the phase limbs, wherein each phase limb is connected to adjacent ones of the other phase limbs at a location of the phase limb between the ends of the phase limb.

In some embodiments, the limbs of the magnetic core have a circular cross-section. In some embodiments, the limbs of the magnetic core have a square or rectangular cross-section.

In some embodiments, each of the control windings constitutes a portion of the corresponding secondary winding.

In some embodiments, the electrical power control apparatus includes one or more rectifier windings around respective portions of the magnetic core to generate electric power for the control windings. In some embodiments, each of the rectifier windings constitutes a portion of the corresponding primary winding.

The electrical power control apparatus may include one or more rectifier components coupled to the rectifier windings, wherein each rectifier component receives an AC input from the corresponding rectifier winding, rectifies the received signal and charges at least one corresponding capacitor, wherein the at least one corresponding capacitor provides the electric power for at least one of the control windings. Each rectifier component may be configured to correct the power factor of the corresponding electrical phase.

The electrical power control apparatus may include one or more inverter components, each inverter component being coupled to the at least one corresponding capacitor and at least one of the corresponding control windings, and configured to generate the control signal for at least one of the control windings. The electrical power control apparatus may include a control component to control operation of the one or more inverter components.

The electrical power control apparatus may include control components to generate, for each of the phases of electric power, the corresponding control signal that is applied to the corresponding control winding to dynamically control the magnetic flux through the corresponding phase limb and consequently the corresponding output signal at the corresponding secondary winding.

The one or more electrical attributes may be selected from AC voltage and harmonic content or harmonic distortion.

Also described herein is an electrical power control apparatus, including:
a magnetic core having a plurality of phase limbs for respective phases of electric power, each of the phase limbs being interconnected to the other phase limbs at respective ends of the limb;
primary windings around the respective phase limbs to receive input electrical energy in the form of input signals for respective electrical phases and generate corresponding magnetic fluxes in the phase limbs;
secondary windings around the respective phase limbs to generate output electrical energy in the form of output signals for respective electrical phases from magnetic fluxes in the phase limbs; and
control windings around respective portions of the magnetic core to modify the magnetic fluxes in the respective phase limbs in order to control the output signals generated from the secondary windings so that the output signals have one or more electrical attributes that satisfy respective predetermined criteria.

In accordance with some embodiments of the present invention, there is provided a multiphase electric power transformer, including:
a magnetic core having a plurality of phase limbs for respective phases of electric power, each of the phase limbs being interconnected to the other phase limbs at respective ends of the limb;
primary windings around the respective phase limbs to receive input electrical energy in the form of input signals for respective electrical phases and generate corresponding magnetic fluxes in the magnetic core;
secondary windings around the respective phase limbs to generate output electrical energy in the form of output signals for respective electrical phases from magnetic fluxes in the magnetic core.

In some embodiments, the limbs of the magnetic core have a square or rectangular cross-section. In other embodiments, the limbs of the magnetic core may have a circular cross-section.

Also described herein is an electrical power control apparatus, including:
a magnetic core having a plurality of limbs;
primary windings around one or more respective ones of the limbs to receive input electrical energy in the form of input signals and generate corresponding magnetic fluxes in the respective limbs;
secondary windings around one or more respective ones of the limbs to generate output electrical energy in the form of output signals from magnetic fluxes in the respective limbs; and
control windings around respective portions of the magnetic core to receive control signals to modify the magnetic fluxes in respective ones of the limbs in order to modify the output signals generated from the secondary windings so that the output signals have one or more electrical attributes that satisfy respective predetermined criteria;
wherein each of the control windings constitutes a portion of the corresponding secondary winding.

The electrical power control apparatus may include one or more rectifier windings around respective portions of the magnetic core to generate electric power for the control windings, wherein each of the rectifier windings constitutes a portion of the corresponding primary winding.

### BRIEF DESCRIPTION OF THE DRAWINGS

Some embodiments of the present invention are hereinafter described, by way of example only, with reference to the accompanying drawings, wherein:

FIG. 1 is a high-level block diagram of a Faraday Exchanger;

FIG. 2 is a schematic illustration of a three-phase Faraday Exchanger with independent magnetic cores for respective electrical phases;

FIG. 3 is a schematic illustration of a three-phase magnetic core of a three-phase Faraday Exchanger in accordance with an embodiment of the present invention;

FIG. 4 is a schematic illustration of magnetic flux flow in the magnetic core of FIG. 3;

FIG. 5 is a schematic illustration of magnetic flux flow in a magnetic core having no central vertical limbs in accordance with an embodiment of the present invention;

FIG. 6 is a screenshot showing a computer-aided design (CAD) model of a three-phase magnetic core of a three-phase Faraday Exchanger of generally rectilinear form, in accordance with an embodiment of the present invention;

FIG. 7 is a schematic diagram illustrating the flow of primary flux and control flux in the rectilinear magnetic core of FIG. 6;

FIG. 8 is a schematic diagram illustrating one arrangement of primary, secondary, rectifier, and control windings around the various limbs of the rectilinear magnetic core of FIG. 6;

FIG. 9 is a schematic circuit diagram illustrating one configuration for interconnecting the various windings of the rectilinear magnetic core of FIG. 6;

FIG. 10 is a screenshot of a CAD model of the magnetic core of rectilinear triangular prism form shown in FIG. 6;

FIG. 11 is a schematic illustration of a three-phase magnetic core of a three-phase Faraday Exchanger, in accordance with an embodiment of the present invention;

FIG. 12 is a screenshot showing the simulated flux in the triangular prism magnetic core of FIG. 10;

FIG. 13 is a graph showing the waveforms of the output voltages of the three phases as a function of time from the triangular prism magnetic core of FIG. 10;

FIG. 14 is a graph showing the frequency components of a single phase of the output voltage from the triangular prism magnetic core of FIG. 10;

FIG. 15 is a screenshot of a CAD model of the magnetic core of spherical shell form shown in FIG. 11, showing the various windings around different portions of the limbs of the magnetic core;

FIG. 16 is a screenshot showing the simulated flux in the spherical shell magnetic core of FIG. 15;

FIG. 17 is a graph showing the waveforms of the output voltages of the three phases as a function of time from the spherical shell magnetic core of FIG. 15;

FIG. 18 is a graph showing the frequency components of a single phase of the output voltage from the spherical shell magnetic core of FIG. 15;

FIG. 19 is a schematic side-view illustrating a magnetic core winding configuration in accordance with some embodiments the present invention, in which the rectifier windings for each phase constitute a portion of the primary windings for that phase, and the control windings for that phase constitute a portion of the secondary windings for that phase;

FIGS. 20 to 22 are screenshots of CAD models of respective magnetic core configurations (with windings) used for simulations, of YY square form (FIG. 20), spherical form (FIG. 21), and demi-torus form; and

FIGS. 23 to 31 are screenshots of simulation inputs and results for the CAD models of FIGS. 20 to 22, being graphs of the primary current, secondary voltage, and secondary current for each configuration, specifically the square form (FIGS. 23 to 25), spherical form (FIGS. 26 to 28) and demi-torus form (FIGS. 29 to 31).

### DETAILED DESCRIPTION

International Patent Application No. PCT/AU2019/050246, entitled “An electrical power control apparatus and process” (referred to hereinafter as the “Faraday Exchanger application”), describes an electromagnetic apparatus or device, referred to in that application and herein as a “Faraday Exchanger”, that receives input electrical energy in the form of an AC input signal having some voltage waveform and root-mean-square (RMS) voltage amplitude, and converts that input electrical energy to output electrical energy in the form of an output signal having a desired or ‘target’ voltage waveform, and a desired or ‘target’ output RMS voltage. The input electrical energy typically varies over time (that is, its AC voltage waveform and/or its RMS voltage is time-dependent), and thus the apparatus operates to dynamically control the conversion so that the output electrical energy has the desired target voltage waveform and target RMS voltage independently of the input voltage waveform and RMS voltage, and dynamic variations of those input characteristics. The dynamic control is achieved by the dynamic control of magnetic flux coupling in a magnetic core.

Additionally and simultaneously, the output electrical energy of the Faraday Exchanger has a power factor determined by the downstream load drawing power from the Exchanger. The Faraday Exchanger determines that power factor on its output, and provides a unity power factor on its input, such that (the input of) the Exchanger appears as an ideal (i.e., purely resistive) load.

The Faraday Exchanger is thus able to provide voltage waveform and RMS voltage conversion while simultaneously providing power factor correction. The use of high-speed electromagnetic path modulation instead of the electronic circuit switching used in prior art power electronics devices enables the Faraday Exchanger to deliver improved efficiency and performance (while also electrically isolating the upstream and downstream components).

The Faraday Exchanger is particularly useful when multiple instances of the exchanger are distributed throughout an electric power distribution network to maintain a stable and clean sinusoidal AC waveform with reduced harmonic content and improved power factor throughout the network, particularly when unpredictable and highly variable renewable energy sources such as solar and wind power generators are distributed throughout the network. By dynamically storing and releasing energy to compensate for such variations throughout the network, the overall stability of the network can be maintained. The control of power factor reduces energy losses, and thus improves the power carrying capacity and productivity of the network. The reduction of harmonics increases the efficiency and security of the network. By being able to adjust output voltage in real time depending on grid frequency and rate of change of grid frequency, a change in demand of loads connected to the exchanger is created. Faraday Exchangers can hence support the grid frequency and Rate of Change of Frequency (“RoCoF”) protection within the parameters of grid operation by producing suitable demand response from the loads connected to the exchanger output.

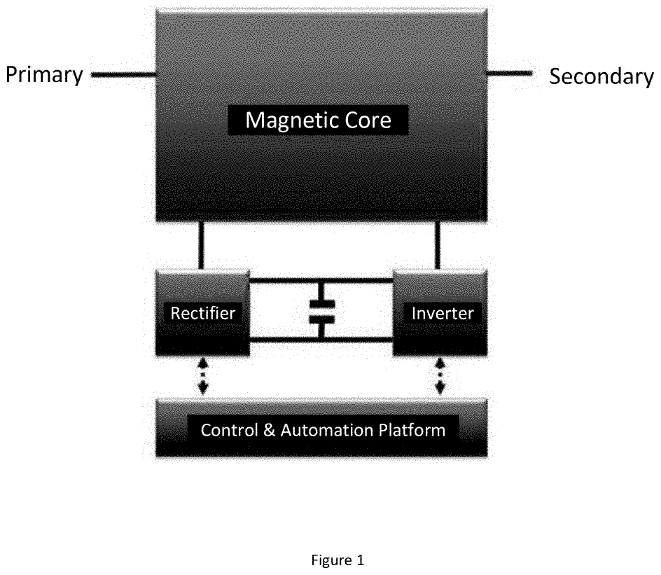

FIG. 1 is a high level block diagram of a Faraday Exchanger. As described in the Faraday Exchanger application, electric power in the form of an input signal is received at the primary windings of a magnetic core, generating a corresponding magnetic flux in the core. Rectifier windings around a corresponding portion of the magnetic core couple a small portion of that magnetic flux to a rectifier component that generates a corresponding DC voltage that is used to charge and store energy in a DC bridge capacitor. That stored energy is, in turn, used by an inverter component to dynamically generate a control signal that is applied to control windings around a corresponding portion of the magnetic core in order to dynamically control the overall flux through secondary windings around the magnetic core, and consequently the output voltage. A control component dynamically controls the operation of the inverter in order to maintain a relatively clean sinusoidal output voltage waveform and the amplitude of that waveform at desired or target values. The control component also dynamically controls the operation of the rectifier in order to improve the power factor. Details of the control processes executed by the control component are described in the Faraday Exchanger application, the entirety of which is hereby expressly incorporated by reference.

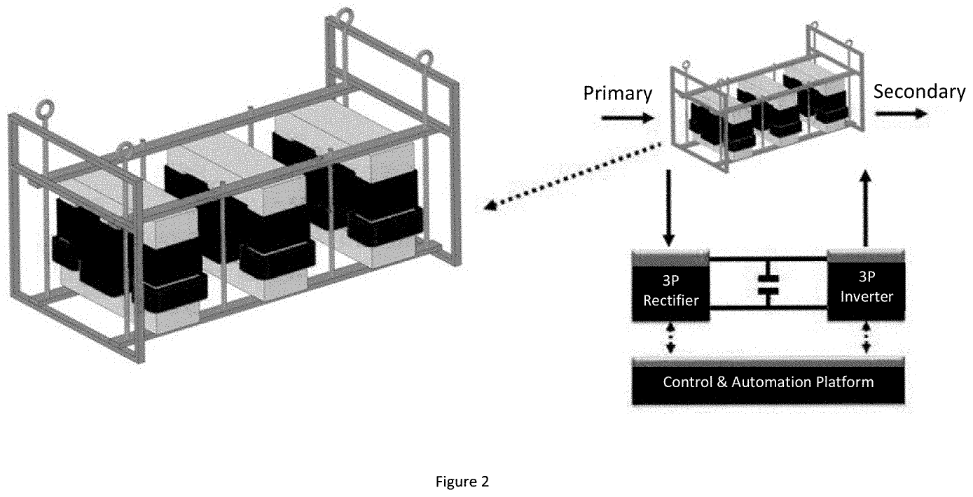

When applied to three-phase power, a three-phase (“3P”) Faraday Exchanger includes three of the magnetic cores described above in parallel, one for each phase, with a single control component configured to dynamically control and coordinate the operation of all three magnetic cores, as illustrated schematically in FIG. 2.

Although the three-phase Faraday Exchanger has been demonstrated to be extremely capable at maintaining a stable and clean supply of electric power in the face of unpredictable and highly variable injected power, there is nevertheless room for improvement. In particular, the magnetic cores are heavy and rather costly.

In order to alleviate these difficulties, the inventors have developed a multi-phase magnetically coupled core that forms the basis of a new form of multi-phase Faraday Exchanger. For example, in the case of three-phase power, a three-phase Faraday Exchanger need include only one magnetic core, namely a three-phase magnetically coupled core as described herein, rather than the three separate magnetic cores described in the Faraday Exchanger application. The use of only one magnetic core not only provides substantial cost and weight savings, but also reduces iron losses, and enables the transfer of energy between phases to occur entirely in the magnetic domain. As described below, a magnetically coupled multi-phase core also provides other performance benefits.

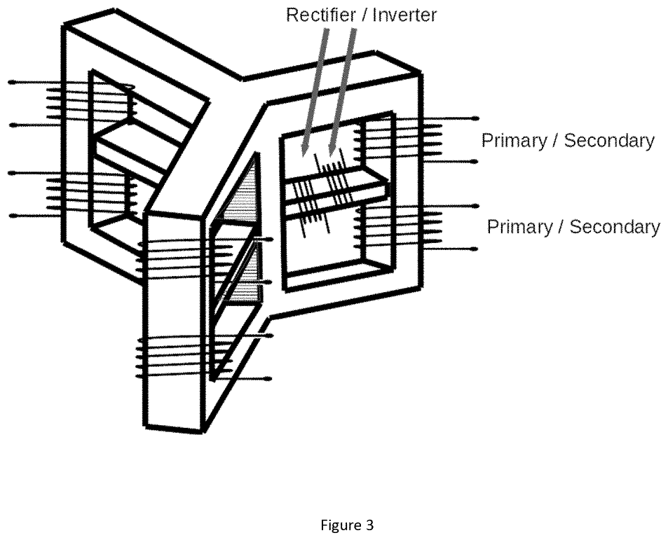

FIG. 3 is a schematic drawing of a three-phase magnetic core in accordance with one embodiment of the present invention. This form of magnetic core is referred to herein as a “YYY” configuration because it consists of three interconnected layers, each of which is in the form of a “Y” in plan view, i.e., three identical limbs extending radially from a common central junction, with the angle between adjacent limbs of each layer being 120°. In the illustrated embodiment, these layers are interconnected by way of four vertical limbs, three of which interconnect the respective outward ends of the “Y” layers at the periphery of each layer, and a fourth interconnecting the central portion of each “Y” layer. It will be apparent that the geometrical relationship between the limbs mirrors the phase relationship between the different electrical phases. Thus in the illustrated three phase embodiment, there is a 120° (geometrical or phase) angle between the limbs and the electrical phases. This common relationship has the effect of cancelling harmonics of every order that is a power of the order of rotational symmetry of the core, in this case powers of three (i.e., harmonics of order three, six, nine, twelve, etc.). Even order harmonics are also cancelled. These and other improvements also reduce the work performed by (and switching losses in) the rectifier and inverter components, thus reducing hardware costs and improving reliability.

Primary and secondary windings for each phase are arranged around the corresponding peripheral vertical limbs interconnecting the central layer with the top and bottom layers of the magnetic core. The rectifier and control windings for each phase are wound around the corresponding horizontal limb of the central Y-shaped layer of the magnetic core.

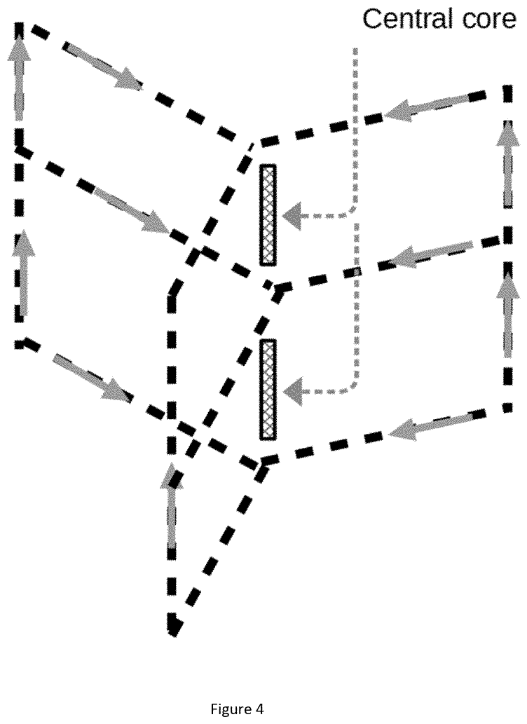

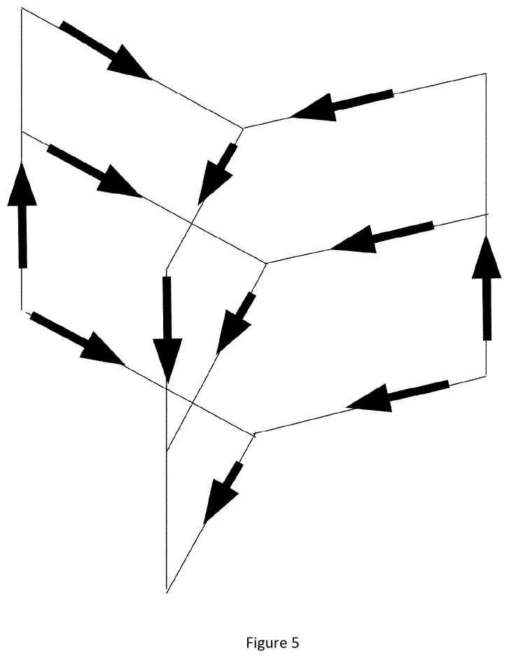

A particular advantage of the multi-phase magnetic cores described herein is the significant reduction in the total volume of core material required, relative to using multiple separate magnetic cores for respective electrical phases. This factor alone provides a significant reduction in volume, mass, and cost of a three-phase Faraday Exchanger. Additionally, magnetic modelling of this core configuration reveals that the magnetic flux flows effectively cancel each other in the central vertical limbs interconnecting the central layer to the top and bottom layers of the magnetic core, as illustrated schematically in FIG. 4. Consequently, the central vertical limb can be omitted from the magnetic core. FIG. 5 is a schematic illustration of balanced re-partition of magnetic fluxes generated from the three electrical phases, distinguished herein by the labels “A”, “B” and “C”.

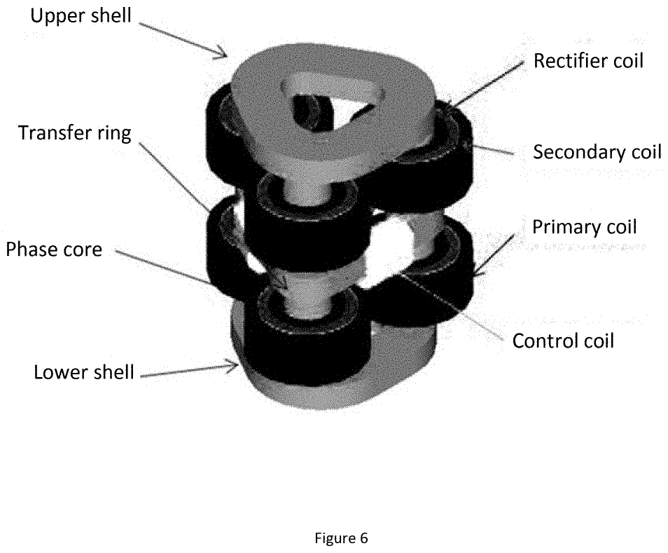

FIG. 6 is a computer-generated image of a three-phase magnetic core in accordance with an embodiment of the present invention in which the configuration of the magnetic core can be described as a wireframe representing a triangular prism. This form of magnetic core is also described herein as a “DDD” configuration because it consists of three interconnected layers, each of which is in the form of an equilateral triangle or the Greek capital letter Delta “Δ”, with the angle between adjacent limbs of each layer being 60°, although in practice the vertices of the triangle are rounded to avoid having sharp corners. The three triangular layers are interconnected only by vertical limbs at the periphery of the core, each of which interconnects the corresponding vertex of the central layer with the corresponding respective vertices of the top and bottom layers. For the reason described above, the magnetic core does not have a central limb.

In this embodiment, the primary, secondary, and rectifier windings for each phase are wound concentrically in a stacked arrangement around the corresponding vertical limbs interconnecting the corresponding vertex of the central layer with the respective vertices of the top and bottom layers. That is, for each vertical limb the corresponding rectifier windings are wound directly onto the corresponding vertical limb, the corresponding secondary windings are wound over the rectifier windings, and the corresponding primary windings are wound over the secondary windings. The control windings for each phase are wound around a corresponding horizontal limb of the central layer.

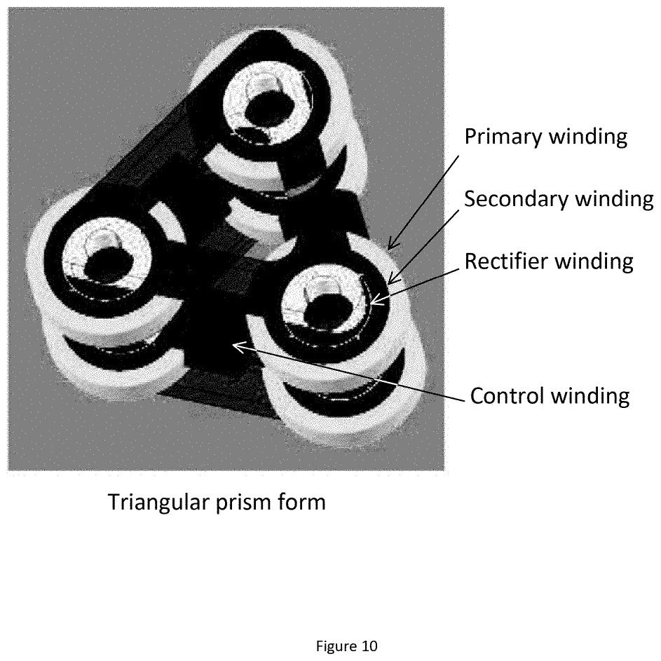

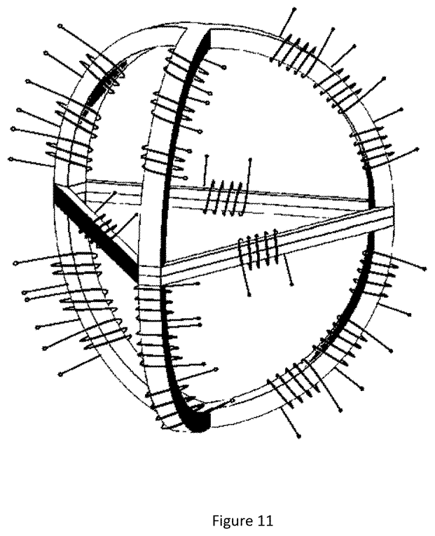

The three-phase magnetic cores of FIGS. 3 to 10 are relatively straightforward to manufacture as they consist of straight limbs of square or rectangular (or circular in the case of the vertical limbs shown in FIG. 6) cross-section that are arranged either horizontally or vertically, as is the case in a conventional non-toroidal transformer. For convenience of reference, this generally rectilinear configuration of magnetic core is referred to herein as being of “square form”. However, the inventors have devised alternative forms of the magnetic core in which at least some of the limbs have a curved geometry that lies on the surface of a sphere. For example, the embodiment shown in FIG. 11 consists of a central horizontal triangular (or “Δ”) layer similar to that of the embodiment described above, interconnected by three peripheral limbs, each being in the form of a part-circular arc. This form of magnetic core is therefore referred to as a “YDY” configuration core. The part-circular curvature of the vertical limbs allows them to replace not only the vertical limbs but also the top and bottom layers of the embodiment shown in FIG. 6. In other embodiments, as described below, the limbs of the central horizontal layer also have a curved geometry that lies on the same spherical surface, in which case the magnetic core can be described as a spherical surface configuration core.

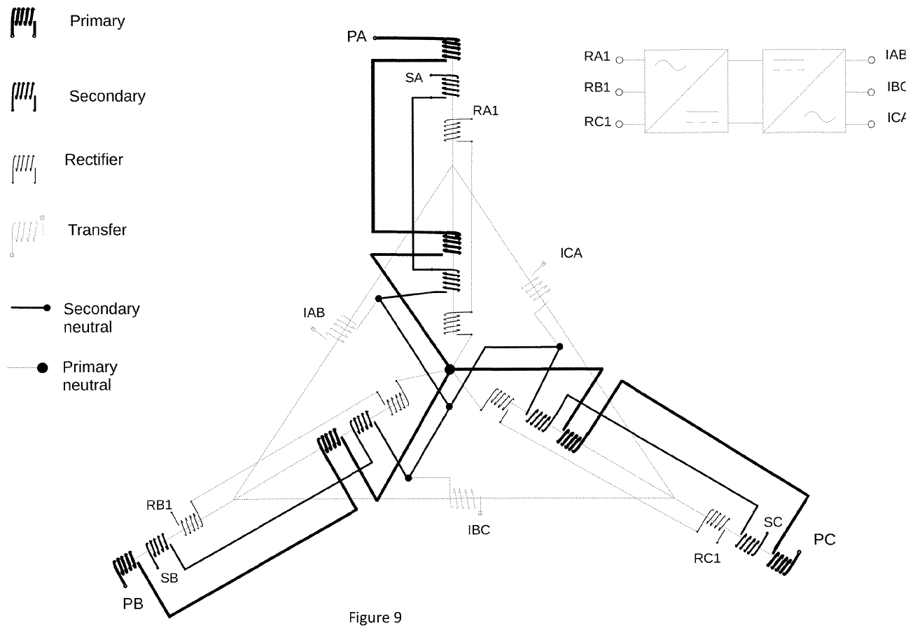

As shown in FIG. 11, each of the primary, secondary, and rectifier windings for each phase can be wound around the corresponding curved limb of the magnetic core, with the control windings for each phase being wound around the corresponding horizontal limb of the central layer. FIG. 9 is a corresponding schematic plan view circuit diagram showing how the secondary, rectifier, and control windings can be interconnected for each of the three phases A, B, and C.

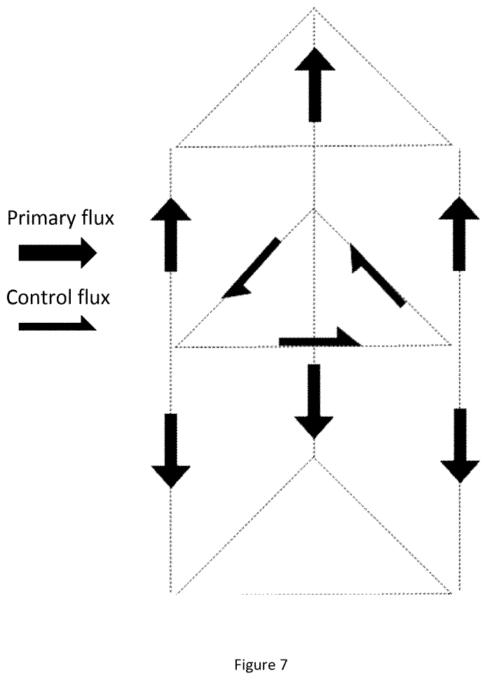

Returning to the square form embodiment illustrated in FIG. 6, FIG. 7 is a schematic illustration of the flux paths in the three-phase magnetic core, wherein primary magnetic flux flows in the vertical limbs, and control flux flows through the horizontal limbs of the central layer.

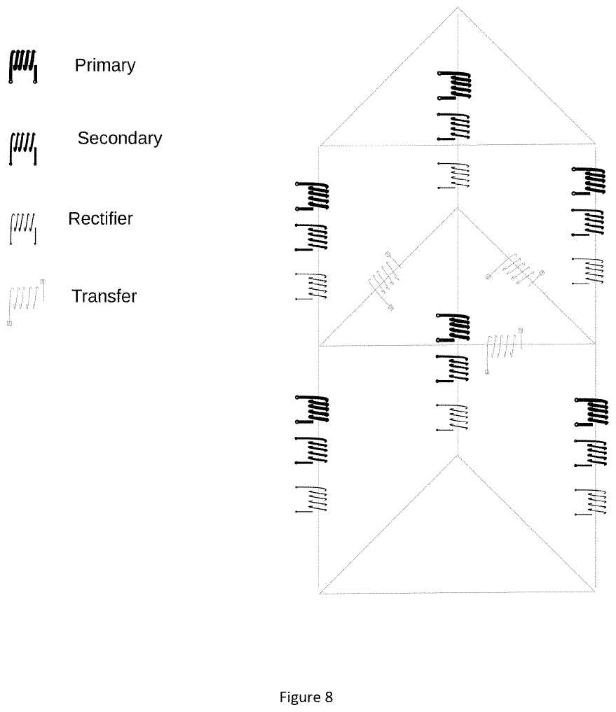

The three-phase magnetic core configurations described herein support considerable flexibility in the arrangement of windings around the various limbs of the magnetic core. For example, FIG. 8 is a schematic diagram illustrating an arrangement of windings in which the primary, secondary, and rectifier windings for each phase are wound around the corresponding vertical limbs of the magnetic core, and the control windings for the three phases are wound around respective horizontal limbs of the central layer of the magnetic core.

The electromagnetic performance of the three-phase magnetic cores described herein can be simulated using an electromagnetic stimulator platform, in this instance Altair Flux3D, as described at https://www.altair.com/flux/. The simulations described below were generated for a signal frequency of 50 Hz at time steps of 300 μs (i.e., 60 steps per cycle), for a 10 kVA core with the following parameters:
Primary voltage peak value 166V;
Primary turns: 117;
Secondary turns: 65;
Rectifier turns: 10;
Inverter turns: 10;
core material: thyssenkrupp Powercore® M400-50A non-grain oriented (NGO) electrical steel.

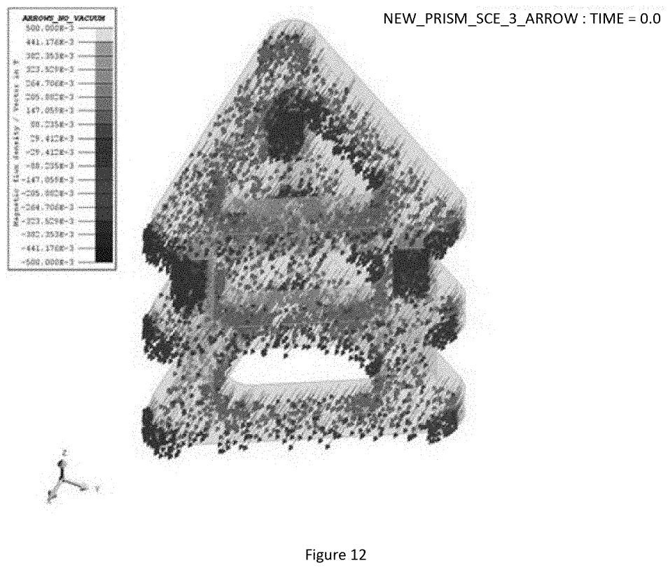

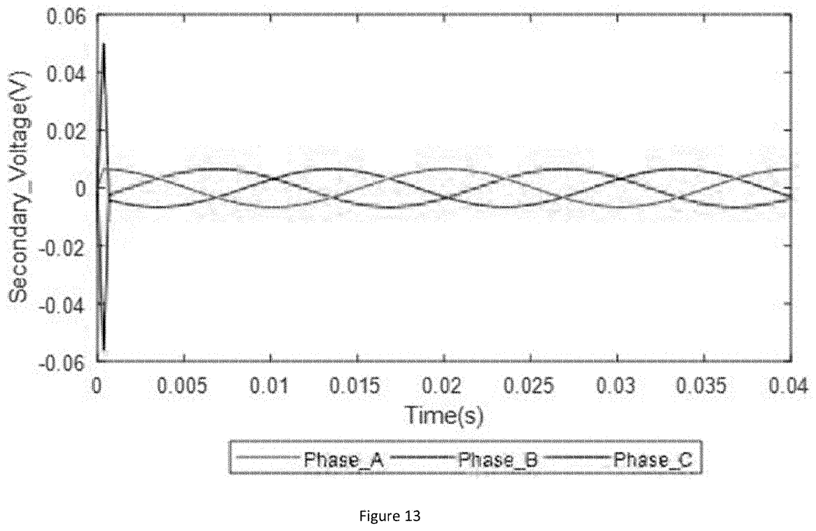

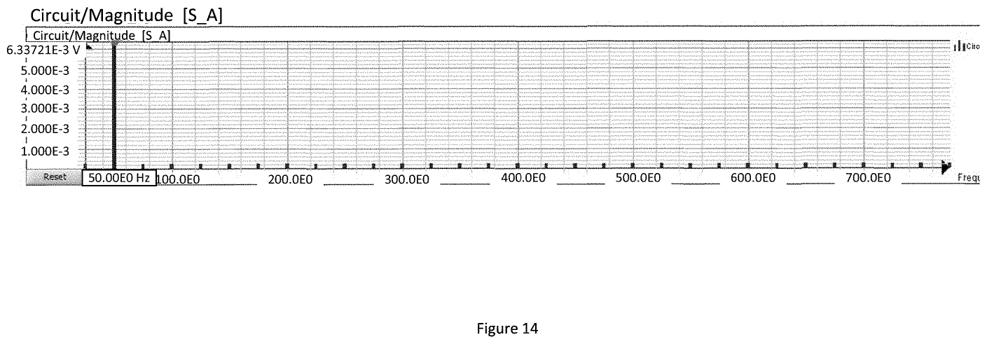

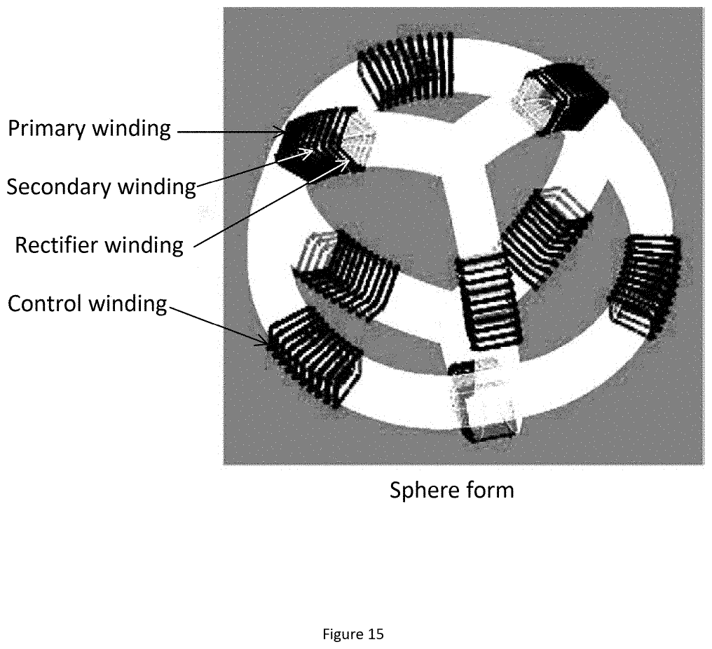

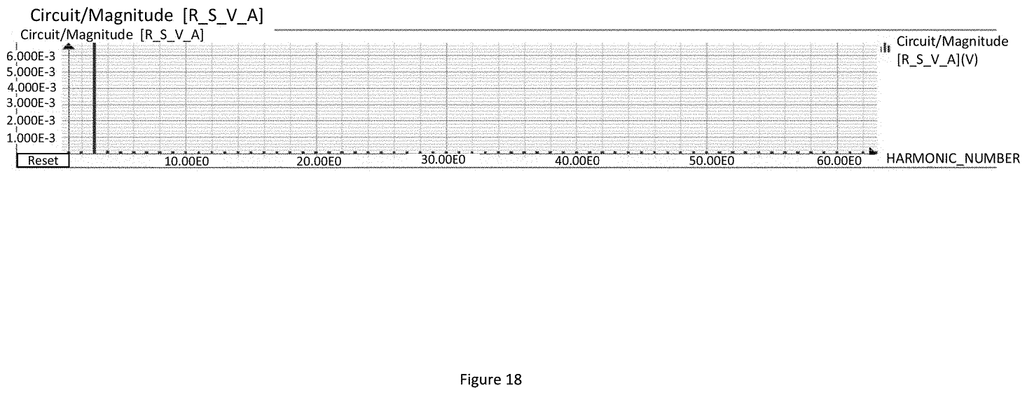

FIG. 12 is a screenshot showing the calculated flux density in the rectilinear three-phase magnetic core configuration of FIG. 6, and FIG. 13 is a graph showing the corresponding output voltages of the three phases as a function of time. Noting that the initial peaks in the graph are simply artefacts of the simulation process, the output waveforms taken from the secondary windings around the magnetic core are clean sinusoidal waveforms spaced by 120°. FIG. 18 is a graph showing the frequency components of the output voltage from one phase, consisting of the ideal mains frequency (in this example, 50 Hz) component, with only relatively minor components from higher frequency harmonics at 25 Hz spacings (the total harmonic distortion being <1%).

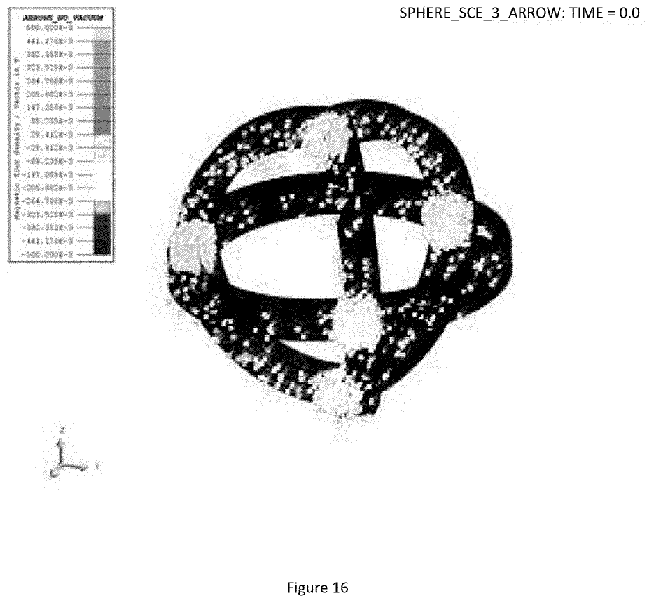

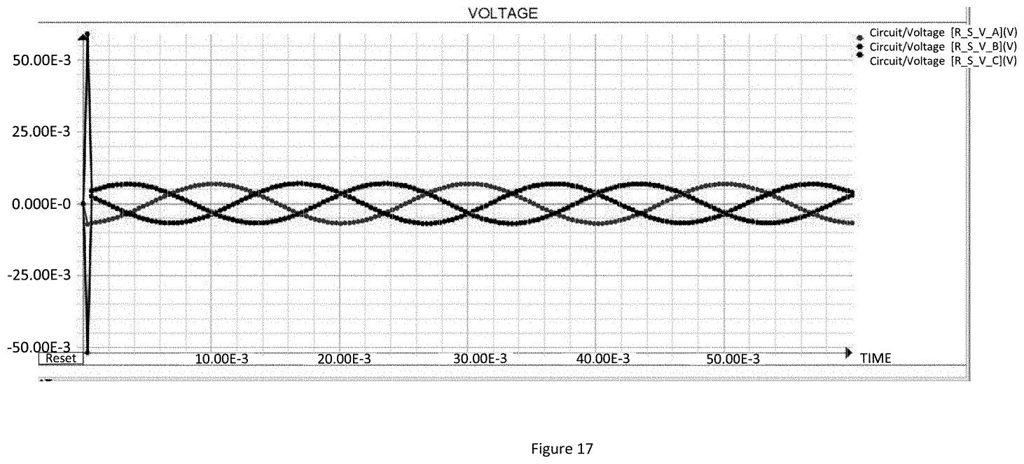

Similarly, FIG. 16 is a screenshot showing the simulated magnetic flux in a spherical shell three-phase magnetic core, with magnetic flux concentrated at the vertices of the core. FIG. 17 is a graph showing the simulated output voltage across the secondary windings of the magnetic core as a function of time for the three phases, showing a clean sinusoidal waveform. Finally, FIG. 18 is a graph showing the frequency components of the output voltage for one phase. As with the rectilinear core configuration, the output voltage is dominated by the ideal mains frequency of 50 Hz, with harmonics present only at relatively low levels.

Windings

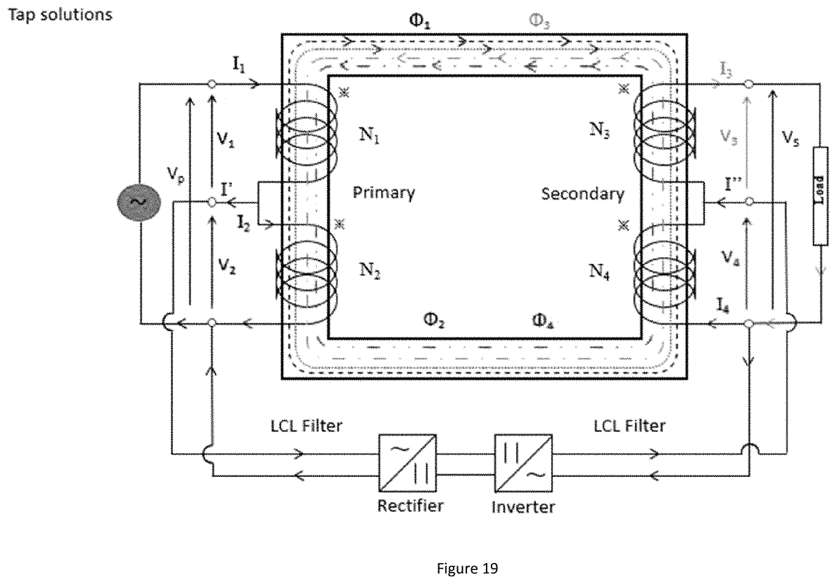

In addition to the advantages resulting from the new multi-phase magnetic core configurations, the inventors have also devised improvements to the core windings. In particular, inventors have determined that is not necessary for the rectifier and control windings to be physically separate to the primary and secondary windings and to be wound around horizontal limbs of the core. In particular, as shown in FIG. 19, the rectifier winding for a phase can be provided by a portion of the corresponding primary winding, and the control winding for that phase can be provided by a portion of the secondary winding.

On the primary side, the relevant equations are as follows:

$${V}_{1} = {N}_{1} [ \frac{d}{dt} ( {Φ}_{1} + {Φ}_{2} - {Φ}_{3} - {Φ}_{4} ) ] + {I}_{1} {R}_{1}$$

$${V}_{2} = {N}_{2} [ \frac{d}{dt} ( {Φ}_{1} + {Φ}_{2} - {Φ}_{3} - {Φ}_{4} ) ] + {I}_{2} {R}_{2}$$

$${V}_{p} = ( {N}_{1} + {N}_{2} ) [ \text{?} ( {Φ}_{1} + \text{?} - {Φ}_{3} - {Φ}_{4} ) ] + ( {I}_{1} {R}_{1} + {I}_{2} {R}_{2} )$$

$$\text{?} \text{indicates text missing or illegible when filed}$$

and on the secondary side:

$${V}_{3} = {N}_{3} [ \frac{d}{dt} ( {Φ}_{1} + {Φ}_{2} - {Φ}_{3} - {Φ}_{4} ) ] - {I}_{3} {R}_{3}$$

$${V}_{4} = {N}_{4} [ \frac{d}{dt} ( {Φ}_{1} + {Φ}_{2} - {Φ}_{3} - {Φ}_{4} ) ] - {I}_{4} {R}_{4}$$

$${V}_{s} = ( {N}_{3} + {N}_{4} ) [ \text{?} ( {Φ}_{1} + \text{?} - {Φ}_{3} - {Φ}_{4} ) ] - ( {I}_{3} {R}_{3} + {I}_{4} {R}_{4} )$$

$$\text{?} \text{indicates text missing or illegible when filed}$$

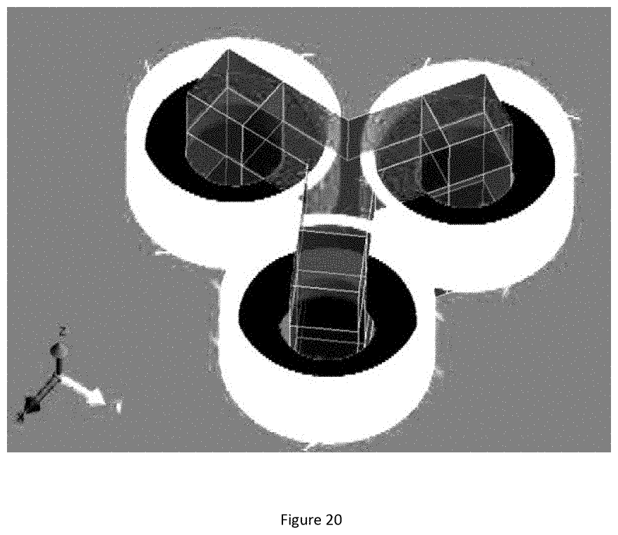

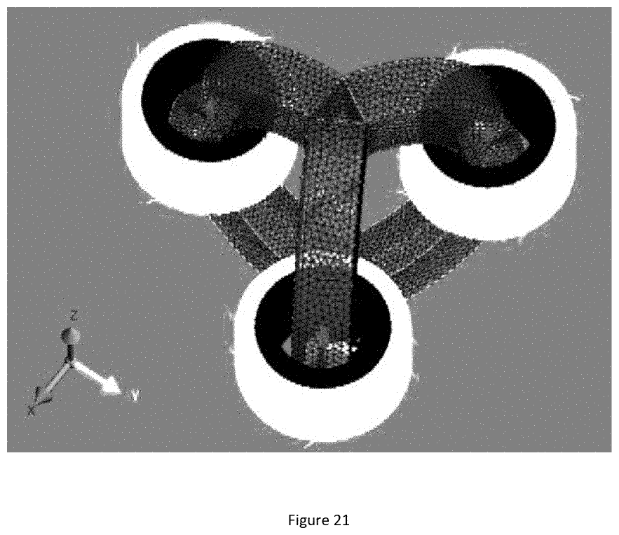

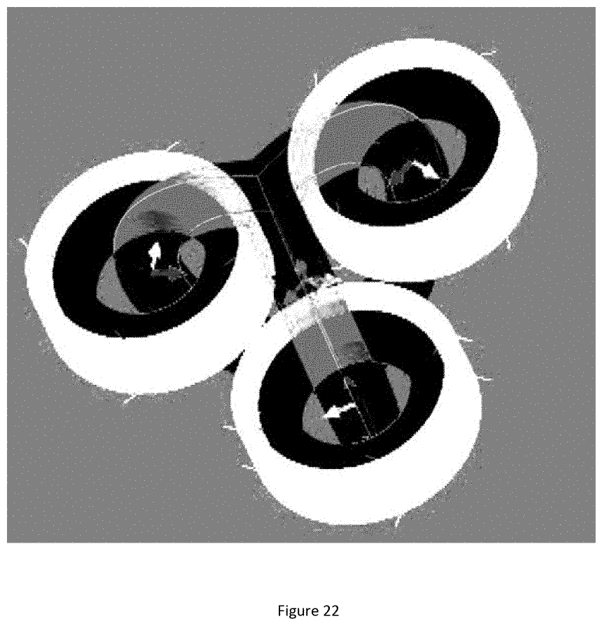

This provides a significant reduction in the amount of copper wire required, reducing copper wire energy losses, and significantly reducing the size, weight and cost of the core. Moreover, this allows the central horizontal limbs to be entirely omitted, enabling new and simplified rectilinear and spherical core configurations as shown in FIGS. 20 and 21, with concomitant reductions in size, weight and cost. As shown in FIG. 22, the inventors have also developed a further core variant similar to the spherical core configuration of FIG. 21, but in which the limbs have a circular cross-section rather than the square cross-section of the spherical core configuration. This embodiment is found to avoid the saturation observed in limb edge regions of the square cross-section spherical configuration, and thus provides reduced losses and lower mass. This configuration is referred to herein as a “demi-torus” configuration, because each of the vertical limbs is in the shape of a part-torus.

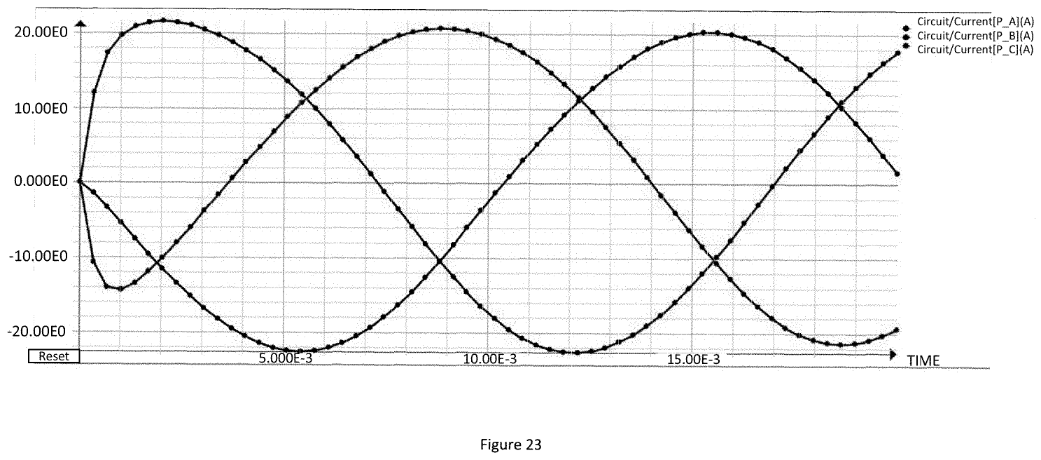

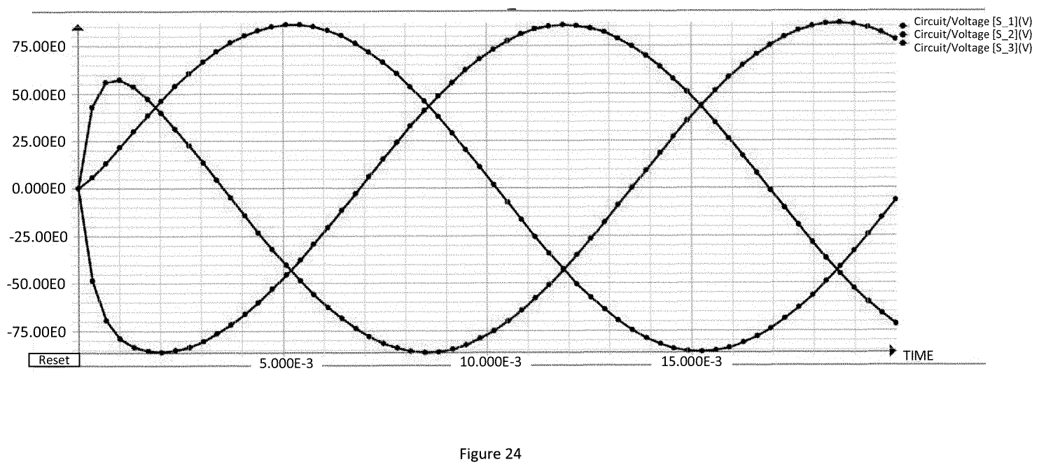

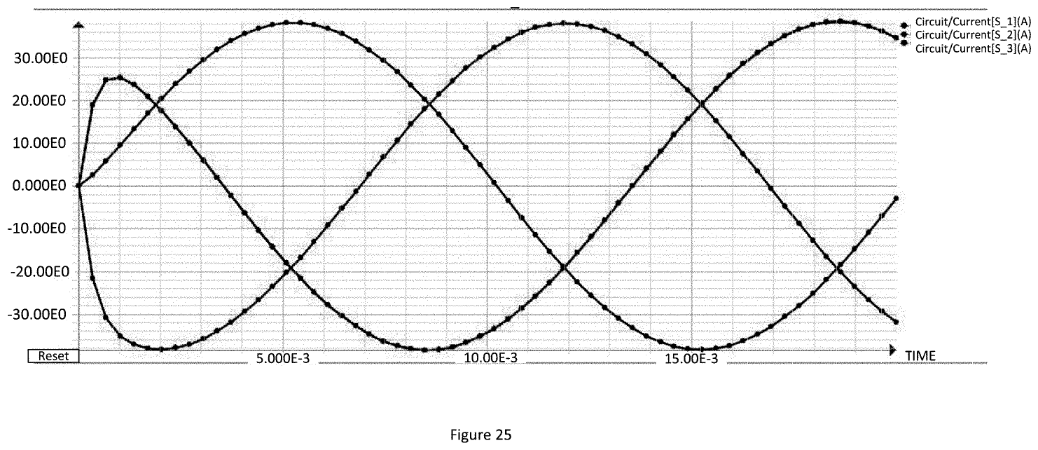

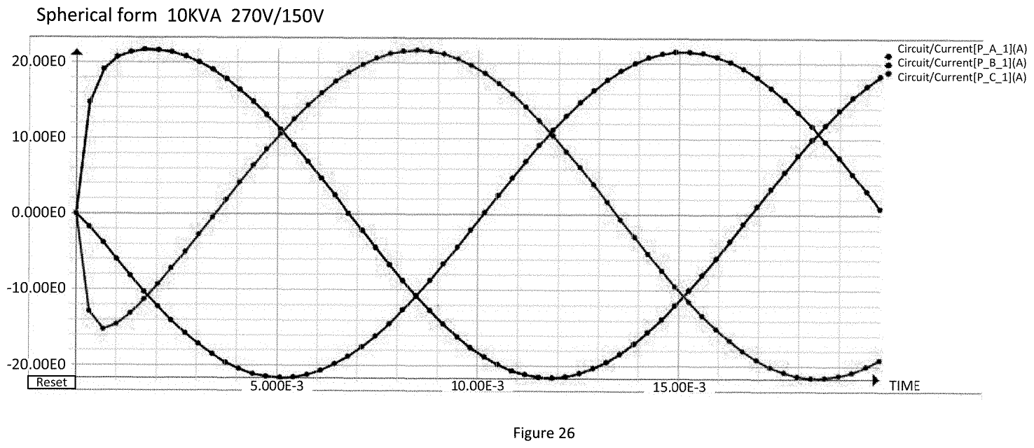

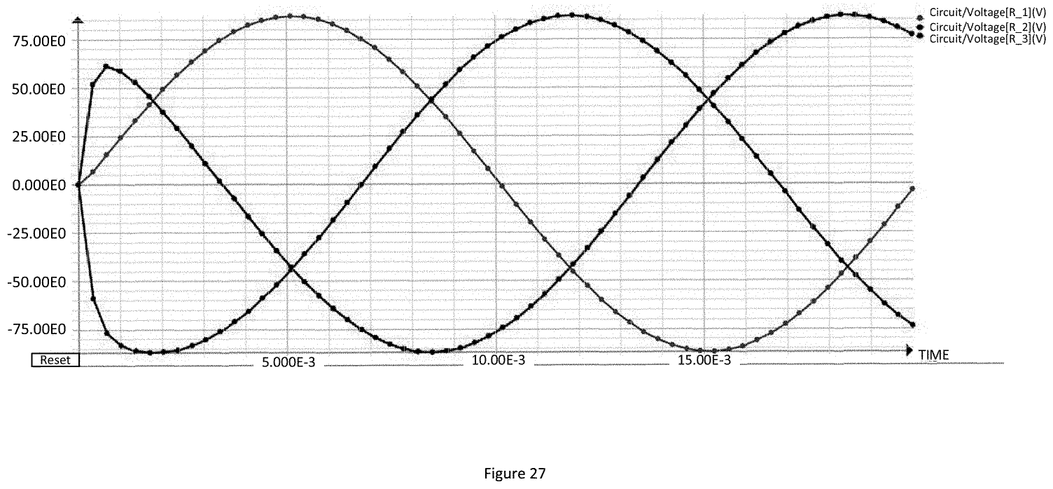

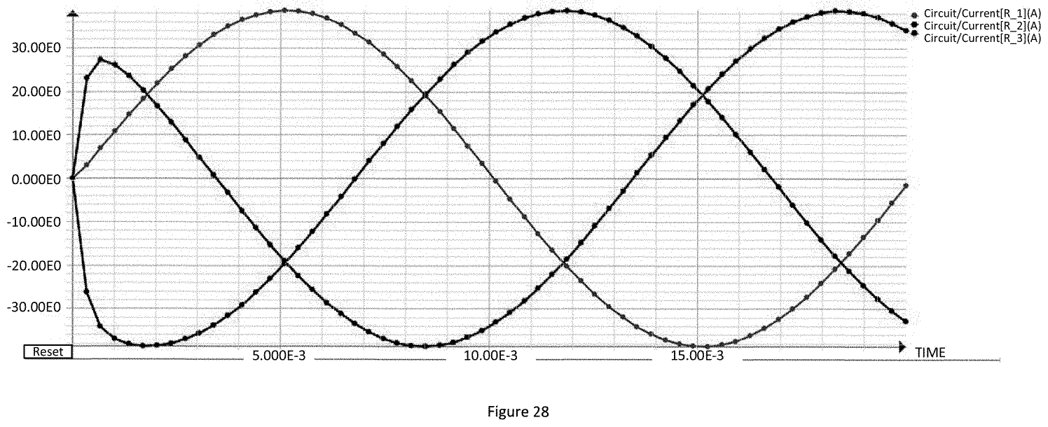

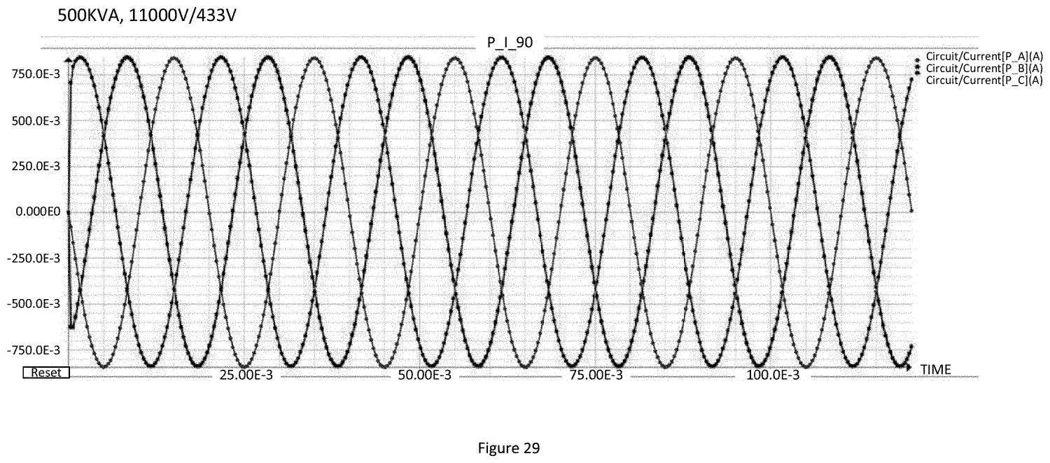

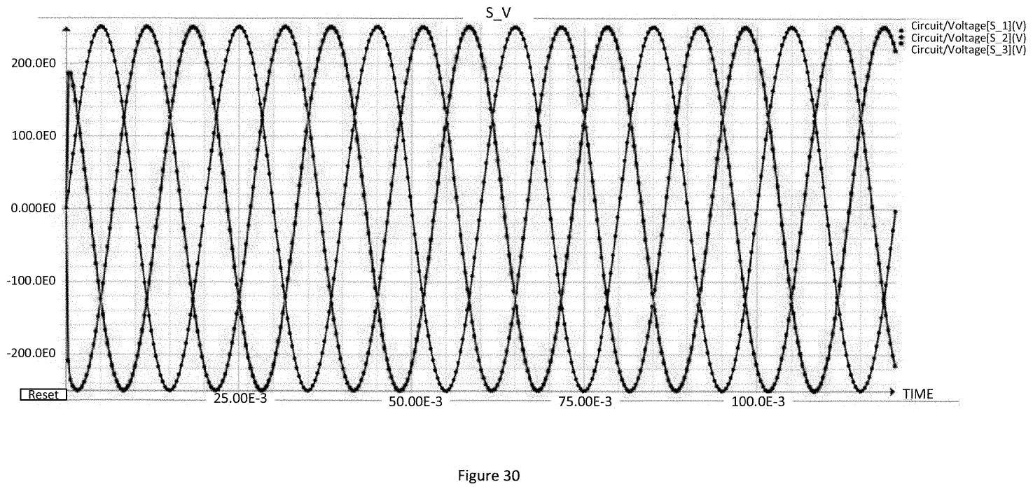

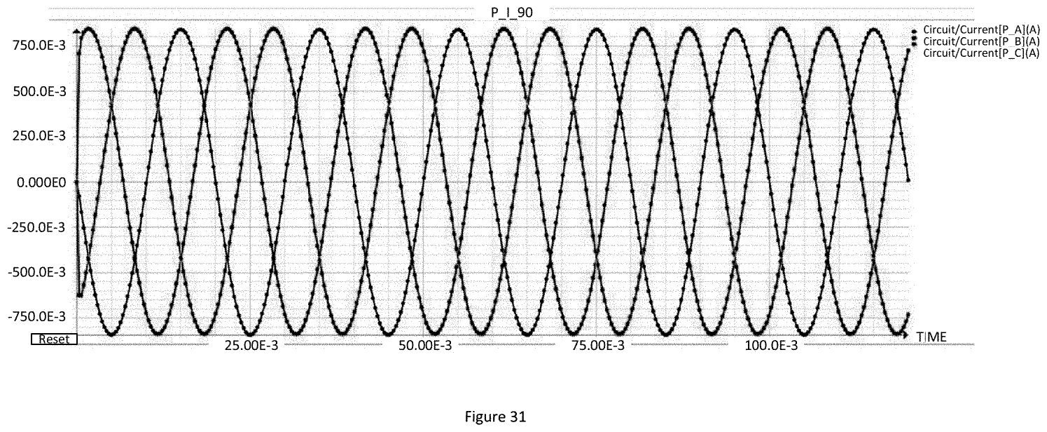

To demonstrate the performance of these three magnetic core configurations, the primary current, secondary voltage, and secondary current in each configuration was simulated as described above, and the results are shown in FIGS. 23 to 31 for the square form (FIGS. 23 to 25), spherical (FIGS. 26 to 28) and demi-torus (FIGS. 29 to 31) configurations. It is clear that each configuration produces clean sinusoidal outputs with no apparent harmonics for all three electrical phases.

TABLE 1
Material Analysis: NGO vs GOES

| @50 Hz | Cogent M470-50A | | | Cogent M095-27P | | |
|---|---|---|---|---|---|---|
| Square | P_I | S_V | Saturation | P_I | S_V | Saturation |
| Form −mm | Target: 21A | Target: 86v | 1.5T | Target: 21A | Target: 86.6v | 1.9T |
| 60 | Out of shape | 82.6 to 85.1 | Large area | Out of shape | 83.0 to 84.9 | Large area |
| | −57.6 | | | −56.0 | | |
| 86 | Imbalanced | 84 to 85.6 | 4 corners | Imbalanced | 84.3 to 85.8 | 4 corners |
| | −27.1A | | | −24.8 | | |
| 90 | Imbalanced | 84.9 to 85.9 | 3 corners | Imbalanced | 85.0 to 86.0 | 3 corners |
| | −26.2 | | | −Phase A | | |
| 100 | Imbalanced | 85.2 to 85.8 | 3 corners | Imbalanced | 85.5 to 86.3 | 3 corners |
| | −24.3 | | | −Phase A | | |
| 110 | Imbalanced | 85.3 to 86.2 | 2 corners | Imbalanced | 85.9 to 86.5 | 2 corners |
| | −23.1 | | | −Phase A | | |
| 120 | Imbalanced | 85.6 to 86.2 | 2 corners | Imbalanced | 86.1 to 86.6 | No saturation |
| | −22.5 | | −light | −22.6 | | |

TABLE 2
Material Analysis: Geometry matter interactions

| Demi Torus | Cogent M470-50A | | | Cogent M095-27P | | |
|---|---|---|---|---|---|---|
| @50 Hz | P_I | S_V | Saturation | P_I | S_V | Saturation |
| mm | Target: 21A | Target: 86v | 1.5T | Target: 21A | Target: 86.6 | 1.9T |
| 60 | Imbalanced | Fully balanced | Conjunction edge | Imbalanced | Fully balanced | No saturation |
| | −46.8 | | | −48 | | |
| 70 | Imbalanced | Fully balanced | Conjunction edge | Fully balanced | Fully balanced | No saturation |
| | −46.8 | | | | | |
| 80 | Fully balanced | Fully balanced | No saturation | Fully balanced | Fully balanced | No saturation |
| 86 | Fully balanced | Fully balanced | No saturation | Fully balanced | Fully balanced | No saturation |

TABLE 3
Material analysis: Negative return to scale

| | | | Primary | | |
|---|---|---|---|---|---|
| | | Core | Current | | |
| | | length | Target | Secondary | |
| Core | Material | mm | 21A | Voltage | Saturation |
| Square | M470- | 60 | × | × | Heavy |
| Form YY | 50A NGO | 86 | 27.6 | √ | Medium |
| | | 120 | √ | √ | Light |
| | M095- | 60 | × | × | Heavy |
| | 27P GO | 86 | 24.8 | √ | Medium |
| | | 120 | √ | √ | No saturation |
| Demi | M470- | 60 | × | √ | Light |
| Torus | 50A NGO | 70 | × | √ | Light |
| Form YY | | 80 | √ | √ | No saturation |
| | M095- | 60 | × | √ | Light |
| | 27P GO | 70 | √ | √ | No saturation |

### Saturation Definitions

Heavy: Large area around corner and limb; Medium: Area around 3-4 corners;

Light: Area around 1-2 corners

TABLE 4
Materials Conclusion: Demi Torus outstanding
Core geometry designed to optimize matter
radiation interactions delivers 3 times better result

| | | Core | Core |
|---|---|---|---|
| | | Diameter | volume |
| Core Form | Material | mm | m³ |
| Square | Cogent M470-50A | 120 | 0.024 |
| YY | NGO | | |
| | Cogent M095-27P | 86 | 0.011 |
| | GO | | |
| Demi Torus | Cogent M470-50A | 80 | 0.012 |
| YY | NGO | | |
| | Cogent M095-27P | 70 | 0.008 |
| | GO | | |

A transformer with the demi-torus magnetic core provides far superior performance, and with substantially lower mass and volume relative to the other configurations described herein. For example, a 500 kVA transformer can be made from a demi-torus core with a core volume of 0.087 m³ and weighing 666 kg. When used as the core of a three-phase Faraday Exchanger, the total weight of the core and windings is 984 kg. When used as the magnetic core of a conventional three-phase transformer, the total weight of the core and windings is 1250 kg.

Although embodiments of the present invention have been described above in the context of three-phase electric power, it should be understood that other embodiments of the invention may support multi-phase or polyphase electric power in which the number of phases is greater than three and the phase difference between respective phases is less than 120°. For example, the number of phases may be 5, 6, 7 or even greater.

Many modifications will be apparent to those skilled in the art without departing from the scope of the present invention.

1. An electrical power control apparatus, including:
a magnetic core having a plurality of phase limbs for respective phases of electric power, each of the phase limbs being interconnected to the other phase limbs at respective ends of the limb;
primary windings around the respective phase limbs to receive input electrical energy in the form of input signals for the respective electrical phases and generate corresponding magnetic fluxes in the phase limbs;
secondary windings around the respective phase limbs to generate output electrical energy in the form of output signals for respective electrical phases from magnetic fluxes in the phase limbs; and
control windings around respective portions of the magnetic core to receive control signals for respective electrical phases to modify the magnetic fluxes in the respective phase limbs in order to modify the output signals generated from the secondary windings so that the output signals have one or more electrical attributes that satisfy respective predetermined criteria.

2. The electrical power control apparatus of claim 1, wherein each of the phase limbs is interconnected to the other phase limbs only at respective ends of the phase limb.

3. The electrical power control apparatus of claim 1, wherein the magnetic core further includes coupling limbs that interconnect the phase limbs, wherein each phase limb is connected to adjacent ones of the other phase limbs at a location of the phase limb between the ends of the phase limb.

4. The electrical power control apparatus of claim 1, wherein the limbs of the magnetic core have a square or rectangular cross-section.

5. The electrical power control apparatus of claim 1, wherein the limbs of the magnetic core have a circular cross-section.

6. The electrical power control apparatus of claim 1, wherein each of the control windings constitutes a portion of the corresponding secondary winding.

7. The electrical power control apparatus of claim 1, including one or more rectifier windings around respective portions of the magnetic core to generate electric power for the control windings.

8. The electrical power control apparatus of claim 3, wherein each of the rectifier windings constitutes a portion of the corresponding primary winding.

9. The electrical power control apparatus of claim 7, including one or more rectifier components coupled to the rectifier windings, wherein each rectifier component receives an AC input from the corresponding rectifier winding, rectifies the received signal and charges at least one corresponding capacitor, wherein the at least one corresponding capacitor provides the electric power for at least one of the control windings.

10. The electrical power control apparatus of claim 9, wherein each rectifier component is configured to correct the power factor of the corresponding electrical phase.

11. The electrical power control apparatus of claim 9, including one or more inverter components, each inverter component being coupled to the at least one corresponding capacitor and at least one of the corresponding control windings, and configured to generate the control signal for at least one of the control windings.

12. The electrical power control apparatus of claim 11, including a control component to control operation of the one or more inverter components.

13. The electrical power control apparatus of claim 1, including control components to generate, for each of the phases of electric power, the corresponding control signal that is applied to the corresponding control winding to dynamically control the magnetic flux through the corresponding phase limb and consequently the corresponding output signal at the corresponding secondary winding.

14. The electrical power control apparatus of claim 1, wherein the one or more electrical attributes are selected from AC voltage and harmonic content or harmonic distortion.

15. A multiphase electric power transformer, including:
a magnetic core having a plurality of phase limbs for respective phases of electric power, each of the phase limbs being interconnected to the other phase limbs at respective ends of the limb;
primary windings around the respective phase limbs to receive input electrical energy in the form of input signals for respective electrical phases and generate corresponding magnetic fluxes in the magnetic core;
secondary windings around the respective phase limbs to generate output electrical energy in the form of output signals for respective electrical phases from magnetic fluxes in the magnetic core.

16. The multiphase electric power transformer of claim 15, wherein the limbs of the magnetic core have a square or rectangular cross-section.

17. The multiphase electric power transformer of claim 15, wherein the limbs of the magnetic core have a circular cross-section.
